(19) United States
(12) Patent Application Publication
(10) Pub. No.: US 2025/0367645 A1
(43) Pub. Date: Dec. 4, 2025

(54) Z-SCHEME PHOTOCATALYST FOR TREATMENT OF WASTEWATER

(71) Applicant: THE GOVERNORS OF THE UNIVERSITY OF ALBERTA, Edmonton (CA)

(72) Inventors: Mohamed GAMAL EL-DIN, Edmonton (CA); Lingjun MENG, Edmonton (CA)

(73) Assignee: THE GOVERNORS OF THE UNIVERSITY OF ALBERTA, Edmonton, AB (CA)

(21) Appl. No.: 18/873,787

(22) PCT Filed: Jun. 16, 2023
(86) PCT No.: PCT/IB2023/056288

§ 371 Date: Dec. 11, 2024

Related U.S. Application Data
(60) Provisional application No. 63/353,097, filed on Jun. 17, 2022.

(51) Int. Cl. B01J 23/89; B01J 35/39; B01J 35/50; B01J 37/08; C02F 1/30; C02F 1/72; C02F 101/34; C02F 103/10

(52) U.S. Cl. CPC B01J 23/8993; B01J 35/39; B01J 35/50; B01J 37/08; C02F 1/30; C02F 1/725; C02F 2101/34; C02F 2103/10; C02F 2305/10

(57) ABSTRACT

A novel photocatalyst Bi₂WO₆/NiO/Ag with hierarchical flower-like Z-scheme heterojunction, which exhibited excellent stability and photocatalytic activity over a wide light spectrum, was synthesized. The as-prepared composites were used in the remediation of real oil sands process water (OSPW) and achieved complete removal of aromatics, classical naphthenic acids (NAs). and heteroatomic NAs after 6 h of photocatalytic treatment. The acute toxicity of OSPW was completely eliminated after only 2 hours of treatment. h+, ·OH and O2·—were found to be the major oxidative species in the photocatalytic system. The enhanced photocatalytic efficiency is the result of the unique Z-scheme electron transfer among electron mediator Ag, NiO, and Bi2WO6 and the SPR effect near Ag, which was supported by the DFT calculations of the electronic properties of Bi₂WO₆/NiO/Ag heterostructure.

### RELATED APPLICATIONS

This application claims priority under 35 U.S.C. § 119(e) to U.S. Provisional Patent Application No. 63/353,097, filed Jun. 17, 2022, which is incorporated herein by reference.

### BACKGROUND OF THE INVENTION

The oil sands in northern region in Alberta, Canada, is one of the largest crude oil reserves on earth. Bitumen extraction from oil sands using hot caustic water extraction method produces large volumes of oil sands process water (OSPW). Despite the fact that around 80% of the water are reused, the freshwater intake is still 2-3 m³ to extract one m³ of bitumen. OSPW is a saline solution that contains water, trace metals, inorganics, organics, and suspended solids. It has been reported that OSPW could induce acute and chronic toxicity to both prokaryotes and eukaryotes, such as bacteria, birds, amphibians, fishes, and others. Organic compounds, especially naphthenic acids (NAs), are believed to be the dominant factors for the OSPW toxicity. Therefore, the removal of NAs is considered to be one of the most critical steps to the safe release of OSPW into the environment. NAs are generally divided into classical NAs (O₂-NAs), oxidized NAs (Oxy-NAs), sulfur containing NAs (S-NAs), and nitrogen containing NAs (N-NAs). Visible light driven catalysts such as bismuth tungstate (Bi₂WO₆), have been widely applied in the field of CO2 reduction, NO oxidation, water splitting, disinfection and contaminants removal in water, owing to the high physicochemical stability, low-toxicity and cost-effectiveness. The superior photocatalytic performance of Bi₂WO₆ on the degradation of various organic pollutants in water is confirmed in previous research. However, in the majority of these studies, experiments were usually conducted using commercial chemicals (target pollutants) dissolved in ultrapure water at neutral pH and at concentrations higher than the environmentally relevant concentrations. Seldom of these studies focused on the application of Bi₂WO₆ for the remediation of real industrial wastewater due to the diversity and challenges of treating real industrial wastewater. The range of physicochemical characteristic values of industrial wastewater are wide; the concentration of organics can be as high as thousands of mg/L, with wide pH value, high concentration of solids, and high ionic charge. For example, OSPW is characterized by high alkalinity (pH˜8.5) and salinity (σ≥3.0 mS cm⁻¹) as well as complex composition. Therefore, it is inevitable to explore the photocatalytic degradation behavior of complex organic wastewaters.

The photocatalytic performance of Bi₂WO₆ could be limited, owing to the poor capability for separating the photoinduced charge carriers. Therefore, many attempts have been taken to increase the photocatalytic activity of Bi₂WO₆, namely (1) anionic and cationic dopants; (2) noble metal deposition; and (3) heterojunction photocatalysts. Among numerous semiconductors, nickel oxide (NiO) is a p-type semiconductor with a band gap around 3.6 eV, and it is widely used as gas sensor, solar cells, electrochemical supercapacitors and hydrogenation. NiO and Bi₂WO₆ could form p-n heterojunction catalyst. Nevertheless, the photocatalytic activities of p-n heterojunction may be restricted because of the reduced redox ability of the original electrons and holes.

The problem is that few cost-effective catalysts are available to detoxify oil sands process water (OSPW) to make it safe for its release into the environment. Accordingly, there is a need for new and improved catalysts for the treatment of OSPW to detoxify its environmentally hazardous compounds.

### SUMMARY

This disclosure provides a self-assembled 3D flower-like Bi₂WO₆ that was fabricated via hydrothermal methods followed by the deposition of OD Ag nanoparticles and 2D NiO nanoplates using in-situ light reduction and hydrothermal methods, forming Bi₂WO₆/NiO/Ag Z-scheme heterojunction. The as-obtained materials were freshly prepared and applied for the treatment of real OSPW. These catalysts were carefully characterized by different analytical methods. The photocatalytic performance was evaluated through the removal efficiency of NAs in real OSPW. The OSPW was characterized using mass spectrometry (MS), ion mobility spectrometry (IMS), and synchronous fluorescence spectra (SFS). Through this study, an efficient NA photocatalytic degradation process was investigated and a passive treatment approach for OSPW remediation through solar light-driven photocatalysis was developed.

Accordingly, this disclosure provides a photocatalyst composite, the composite characterized by having a Z-scheme structure of uniformly distributed components, wherein the components of the composite comprise Bi₂WO₆ and NiO, the weight percent of Bi₂WO₆ is at least 85%, and the weight percent of NiO is at least 1%. In some preferred embodiments, the photocatalyst composite comprises silver metal.

Also, this disclosure provides a method for oxidizing a compound comprising irradiating a mixture comprising a photocatalyst composite described above and one or more organic compounds for a sufficient period of time to oxidize the one or more organic compounds.

Additionally, this disclosure provides a method for preparing a photocatalyst composite described herein comprising:
a) autoclaving an aqueous mixture comprising a bismuth(III) salt and a tungstate salt to form Bi₂WO₆;
b) autoclaving a second aqueous mixture comprising the Bi₂WO₆, a urea, fluoride ion, and nickel(II) to form a Bi₂WO₆/NiO composite;
c) calcining the Bi₂WO₆/NiO composite while exposed to air;
d) irradiating a third aqueous mixture of the calcined Bi₂WO₆/NiO composite, a silver salt, and an organic acid to form a plasmonic Bi₂WO₆/NiO/Ag photocatalyst composite; wherein each autoclaving step is at a temperature of at least 120° C.

The invention provides for the use of the compositions described herein for use in the treatment of oil sands process water to detoxify environmentally hazardous compounds.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. X-ray diffraction spectroscopy (XRD) patterns of NiO, Bi₂WO₆, Bi₂WO₆/NiO, Bi₂WO₆/Ag and Bi₂WO₆/NiO/Ag.

FIG. 2. Scanning electron microscopy (SEM) of (a) Bi₂WO₆ and (b) Bi₂WO₆/NiO/Ag; and (c) bright-field scanning transmission electron microscopy (BF-STEM) of Bi₂WO₆/NiO/Ag.

FIG. 3. (a) Photoluminescence spectra of samples; (b) Transient photocurrent responses of samples.

FIG. 4A-B. (a) Trapping measurement with different scavengers (IPA→^{·}OH, AO→h⁺) for the photodegradation of ACA using Bi₂WO₆/NiO/Ag; (b) DMPO-EPR spin-trapping spectra of Bi₂WO₆/NiO/Ag for the detection of ^{·}OH.

FIG. 5. Schematic illustration of proposed photocatalytic mechanisms: the Z-scheme structure.

FIG. 6A-C. Synchronous fluorescence spectra (SFS) of the photocatalytic treatment of OSPW by (a) Bi₂WO₆, (b) Bi₂WO₆/NiO and (c) Bi₂WO₆/NiO/Ag.

FIG. 7A-B. Removal of classical naphthenic acids (NAs) with respect to (a) carbon number and (b) z number.

FIG. 8. Inhibition effect on Vibrio fischeri caused by raw OSPW and OSPW treated with Bi₂WO₆/NiO/Ag (the inhibition is zero for 2 hours onward).

FIG. 9A-B. (a) Photocatalytic degradation of 1-adamantanecarboxylic acid (ACA) using the as-prepared catalysts; (b) cycle experiment of Bi₂WO₆/NiO/Ag for ACA photocatalytic degradation.

### DETAILED DESCRIPTION

As described herein, Z-scheme systems were employed to avoid the decrease of redox potential, meanwhile keeping the capability to separate photo-generated electron-hole pairs effectively. However, the directional migration of traditional charge carriers usually competes with that in two phase Z-scheme heterojunction. In this case, an electron mediator is introduced to enhance the Z-scheme charge transfer based on the difference of electrical resistances between different phases. Noble metals such as gold and silver, which could induce surface plasmon resonance (SPR), are employed as electron mediator in Z-scheme systems.

Additional information and data supporting the invention can be found in the following publication by the inventors: Journal of Hazardous Materials, 413 (2021) 125396 and its Supporting Information, which is incorporated herein by reference in its entirety.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability, necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units are also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly implied or stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

An “effective amount” refers to an amount effective to bring about a recited effect, such as an amount necessary to form products in a reaction mixture. Determination of an effective amount is typically within the capacity of persons skilled in the art, especially in light of the detailed disclosure provided herein. The term “effective amount” is intended to include an amount of a compound or reagent described herein, or an amount of a combination of compounds or reagents described herein, e.g., that is effective to form products in a reaction mixture. Thus, an “effective amount” generally means an amount that provides the desired effect.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art.

The term “aromatic” refers to either an aryl or heteroaryl group or substituent described herein. Additionally, an aromatic moiety may be a bisaromatic moiety, a trisaromatic moiety, and so on. A bisaromatic moiety has a single bond between two aromatic moieties such as, but not limited to, biphenyl, or bipyridine. Similarly, a trisaromatic moiety has a single bond between each aromatic moiety.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted with a substituent described below. For example, a phenyl moiety or group may be substituted with one or more substituents R^{X} where R^{X} is at the ortho-, meta-, or para-position, and X is an integer variable of 1 to 5.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms, wherein the ring skeleton comprises a 5-membered ring, a 6-membered ring, two 5-membered rings, two 6-membered rings, or a 5-membered ring fused to a 6-membered ring.

The term “noble metal” refers to the metals silver, gold, palladium, platinum, rhodium, iridium, ruthenium, or osmium.

The term “environmentally safe” refers to compounds and compositions that are considered to be not harmful to the environment as determined by a regulatory agency such as the Environmental Protection Agency. The compounds or compositions may be intrinsically benign to the environment, sufficiently less toxic than an unoxidized precursor, or present in sufficiently low concentrations to be considered environmentally unharmful by an environmental regulatory agency.

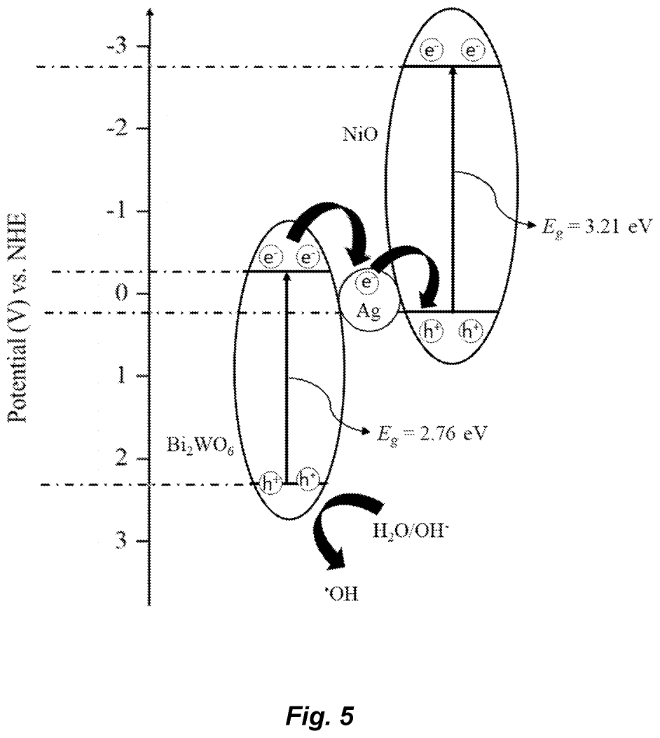

The term “Z-scheme” refers to a type of linear electron transport chain used in photosynthesis. The name is derived from an electron transport scheme that has been depicted in the shape of the letter “Z” (e.g., FIG. 5), as known to persons skilled in the art.

The term “heterojunction” refers to an interface between two layers or regions of dissimilar semiconductor that can have unequal band gaps.

### Embodiments of the Technology

This disclosure provides a photocatalyst composite, the composite characterized by having a Z-scheme heterojunction structure of uniformly distributed components, wherein the components of the composite comprise Bi₂WO₆ and NiO, the weight percent of Bi₂WO₆ is at least 85%, and the weight percent of NiO is at least 1%.

In various embodiments, the components of the composite further comprise a noble metal. In various embodiments, the noble metal is silver metal. In various embodiments, the weight percent of the noble metal is at least 0.5%. In various embodiments, the weight percent of the noble metal is about 1% to about 3%. In various embodiments, the weight percent of NiO is about 1% to about 7%

In various embodiments, the weight percent of NiO or Ag is about 0.1%, about 0.5%, about 1%, about 2%, about 3%, about 4%, about 5%, about 6%, about 7%, about 8%, about 9%, or about 10%.

In some embodiments, the weight percent of NiO is about 1% to about 7%, and weight percent of the noble metal is about 1% to about 3%. In some embodiments, the weight percent of Bi₂WO₆ is at least 90%. In various embodiments, the weight percent of Bi₂WO₆ is about 85%, about 86%, about 87%, about 88%, about 89%, about 90%, about 91%, about 92%, about 93%, about 94%, about 95%, about 96%, about 97%, about 98%, or about 99%.

In preferred embodiments, the weight percent of Bi₂WO₆ is about 93%, the weight percent of NiO is about 5%, and weight percent of the noble metal is about 2%.

In some embodiments, the components of the composite consist essentially of Bi₂WO₆, NiO and Ag. In some embodiments, the components of the composite consist of Bi₂WO₆, NiO and Ag.

In various embodiments, the composite is capable of oxidizing an organic compound via Z-scheme charge transfer or Z-scheme electron transfer and/or a surface plasmon effect.

Also, this disclosure provides a method for oxidizing a compound comprising irradiating a mixture comprising a photocatalyst composite disclosed herein and one or more organic compounds for a sufficient period of time to oxidize the one or more organic compounds.

In preferred embodiments, the photocatalyst composite is Bi₂WO₆/NiO/Ag, the weight percent of Bi₂WO₆ is about 93%, the weight percent of NiO is about 5%, and weight percent of the noble metal is about 2%.

In various embodiments, the irradiation wavelength is about 400 nm to about 800 nm. In various embodiments, the irradiation wavelength is about 450 nm, about 500 nm, about 550 nm, about 600 nm, about 650 nm, about 700 nm, or about 750 nm. In various embodiments, the irradiation wattage is about 30 Watts/m² to about 200 Watts/m². In various embodiments, the irradiation wattage is about 30 Watts/m², about 50 Watts/m², about 70 Watts/m², about 90 Watts/m², about 110 Watts/m², about 130 Watts/m², about 150 Watts/m², about 170 Watts/m², or about 190 Watts/m².

In various embodiments, the irradiation is solar irradiation. In various embodiments, the one or more organic compounds comprises naphthenic acids and/or aromatic compounds. In various embodiments, the mixture is an aqueous solution comprising the photocatalyst composite and the one or more organic compounds.

In some embodiments, the sufficient period of time is about 2 hours, about 3 hours, about 4 hours, about 5 hours, about 6 hours, about 7 hours, about 8 hours, about 9 hours, about 10 hours, about 11 hours, about 12 hours, about 15 hours, about 18 hours, about 21 hours, or about 24 hours. In various embodiments, the one or more organic compounds are present in oil sands process water (OSPW) and are oxidized sufficiently to be environmentally safe.

Additionally, this disclosure provides a method for preparing a photocatalyst composite disclosed herein, comprising:
a) autoclaving an aqueous mixture comprising a bismuth (III) salt and a tungstate salt to form Bi₂WO₆;
b) autoclaving a second aqueous mixture comprising the Bi₂WO₆, a urea, fluoride ion, and nickel (II) to form a Bi₂WO₆/NiO composite;
c) calcining the Bi₂WO₆/NiO composite while exposed to air;
d) irradiating a third aqueous mixture of the calcined Bi₂WO₆/NiO composite, a silver salt, and an organic acid to form a plasmonic Bi₂WO₆/NiO/Ag photocatalyst composite; wherein each autoclaving step is at a temperature of at least 120° C.

In some embodiments, the mixture of step a) further comprises an organic acid and/or a surfactant. In some embodiments, the Bi₂WO₆/NiO composite is calcined while exposed to oxygen or an atmosphere comprising oxygen. In various embodiments, the Bi₂WO₆ has a flower-like, swirl-like, or nanoplate morphology.

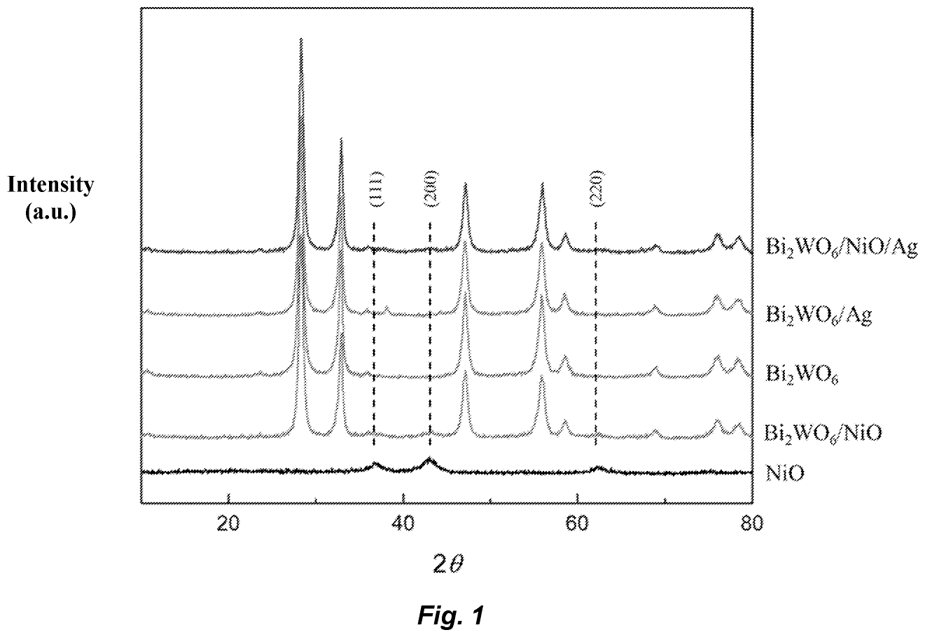

Results and Discussion. Phase structure and composition. XRD was conducted to determine the phase purities and crystallographic structures of the as-prepared materials. The diffraction peaks of pure Bi₂WO₆ in FIG. 1 were well matched to the orthorhombic Bi₂WO₆ (JCPDS card No. 73-1126).

The major diffraction peaks of NiO at 62.9°, 43.31° and 37.31° were ascribed to (2 2 0), (2 0 0) and (1 1 1) reflections of cubic NiO (JCPDS card No. 47-1049), respectively. It can be seen that the Bi₂WO₆/NiO composites retained the crystalline structure of the pristine Bi₂WO₆, which indicated that the crystal structure could not be changed by thermal treatment process. The diffraction peak at 38.1° recorded in the XRD pattern of Bi₂WO₆/Ag composites was in accordance with the cubic Ag (1 1 1) phase (JCPDS card No. 04-0783). Furthermore, compared with the pure Bi₂WO₆ and NiO, there were no new impurity diffraction peaks in the heterojunction materials. The XRD results confirmed the formation of a highly pure ternary crystal structure.

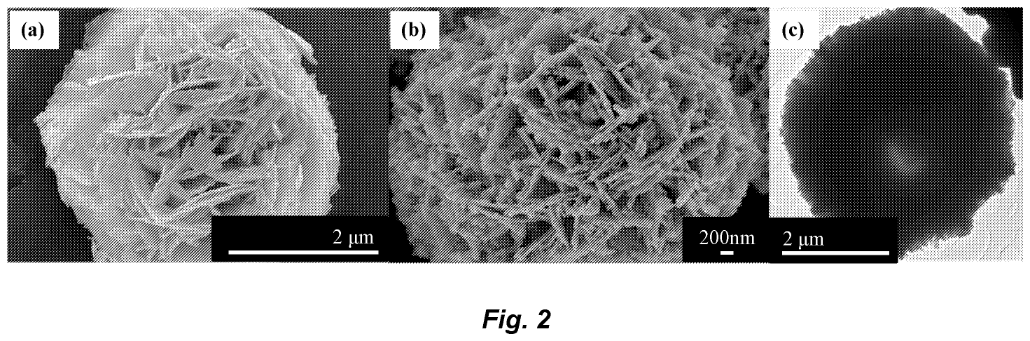

Morphological structure analyses. SEM and TEM were conducted to explore the comprehensive information on the microstructures and morphology of the photocatalysts. As depicted in FIG. 2a, pure Bi₂WO₆ exhibited a flower-like spherical superstructure with a diameter around 4 μm, which was assembled by plenty of nanoplates, forming interspace of different sizes, resulting in the increased specific surface area. Meanwhile, the removal rate of target pollutant increased with increasing surface area. After loading with NiO and Ag, it was clear that some NiO nanoplates were anchored on the surface of Bi₂WO₆, while Ag nanoparticles were not observed (FIG. 2b). Although the surface of Bi₂WO₆/NiO/Ag (FIG. 2b) was rougher than that of pure Bi₂WO₆ (FIG. 2a), their size and shape remained the same. Bright-field scanning transmission electron microscopy (BF-STEM) (FIG. 2c) and high-angle annular dark-field (HAADF)-STEM also confirmed the spherical superstructure of Bi₂WO₆/NiO/Ag. Enlarged images of Bi₂WO₆/NiO/Ag indicated that Ag nanoparticles were successfully and tightly decorated on the Bi₂WO₆. HAADF-STEM elemental mapping further confirmed that Bi, W, Ni and O were evenly distributed throughout the material, whereas Ag was distributed as nanoparticles.

HRTEM images also revealed the coexistence of Ag, NiO and Bi₂WO₆. However, due to the different heights of the sample, the lattice fringes in different regions could not be clearly observed at the same time. Therefore, the lattice fringes focused on different parts of catalyst and corresponded to Bi₂WO₆ (1 1 3), Ag (1 1 1) and NiO (200). These results proved the formation of intimate interfaces between the Ag, NiO and Bi₂WO₆ rather than simple physical mixing, which could avoid the recombination of photoinduced charge carriers at the tight heterojunction interface of Bi₂WO₆/NiO/Ag.

Chemical composition analysis. The surface chemical states of pure Bi₂WO₆ and Bi₂WO₆/NiO/Ag were explored by XPS. Bi, W, O, C elements could be observed in a survey scan spectrum of Bi₂WO₆, while Ni and Ag were detected in Bi₂WO₆/NiO/Ag, which implies that the incorporation of NiO and Ag onto Bi₂WO₆ was successful. The corresponding high-resolution XPS spectra were observed for Bi 4f, W 4f, O Is, Ag 3d and Ni 2p. The binding energies of Bi 4f_{7/2} and Bi 4f_{5/2} located at 158.9 and 164.3 eV belong to the metallic Bi³⁺ in Bi₂WO₆. For Bi₂WO₆/NiO/Ag, peaks located at 158.6 and 163.8 eV were ascribed to Bi³⁺. Characteristic peaks of 35.3 and 37.3 eV for Bi₂WO₆ and 34.8 and 36.9 eV for Bi₂WO₆/NiO/Ag were observed with the binding energies of W 4f_{7/2} and W 4f_{5/2} of W⁶⁺. The O 1s spectrum for Bi₂WO₆ was further deconvoluted into three peaks of 529.9, 530.6 and 532.2 eV and in accordance with lattice oxygen (W—O, Bi—O) and O species in adsorbed H₂O (O—H), respectively. The new peak that appeared in O 1s spectrum of Bi₂WO₆/NiO/Ag was arisen from Ni—O bonds. Moreover, slighted shifts in the banding energy of Bi, W, O were recorded in the spectra of Bi₂WO₆/NiO/Ag, indicating the different electron density induced by interfacial interaction and electron transfer in the heterojunction.

The characteristic peak of Ag 3d_{5/2} was located at 367.5 eV and Ag 3d_{3/2} peak was at 373.6 eV, respectively. The peak located at 872.41 eV and 853.35 eV were assigned to Ni 2p_{1/2} and Ni 2p_{3/2}, demonstrating the presence of Ni²⁺ in NiO. Two satellite peaks at 860.85 eV and 878.85 eV were arisen from shake-up. The peak of Ni 2p_{3/2} at 855.15 eV could be designated as Ni³⁺ in Ni₂O₃. These findings further confirmed the successful introduction of NiO and Ag, which will increase the photocatalytic performance through the separation of e⁻ and h⁺.

Optical and photoelectrical property analysis. The trapping, migration and transfer of the photoinduced holes and electrons on the surface of catalysts were studied by photolum-inescence (PL) emission spectra and photocurrent responses. Generally, an electron was promoted from valence band (VB) to conduction band (CB) under light irradiation. However, the photo-generated charge carriers could simultaneously recombine to release the energy in the form of fluorescence emission, leading to the decreased photocatalytic efficiency. Therefore, the higher intensity of PL signifies the lower separation rate of charge carriers.

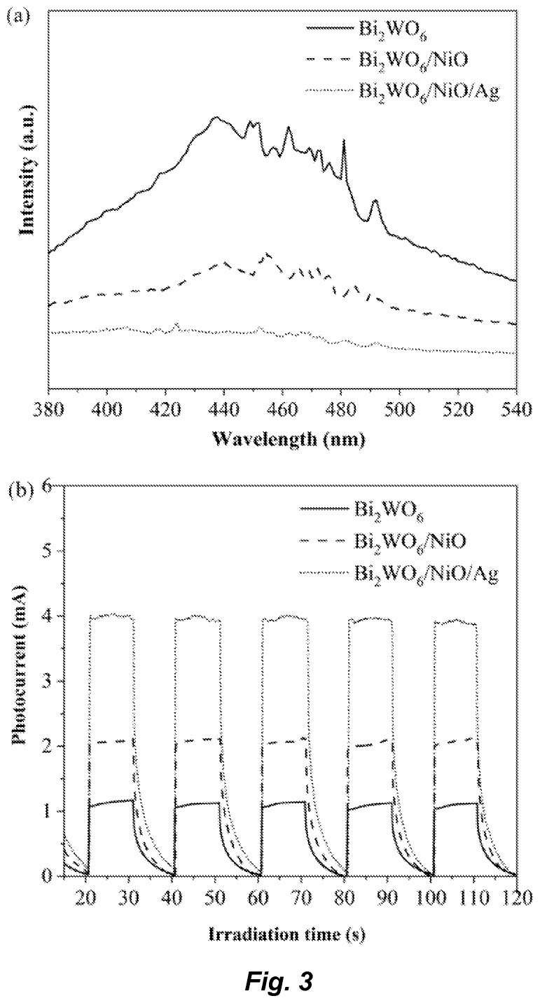

As shown in the FIG. 3a, the intensity of pure Bi₂WO₆ was relatively high due to the intrinsic low quantum yield. While the loads of Ag and NiO on Bi₂WO₆ could decrease the PL intensity, indicating that the formation of heterojunction facilitated the separation of charge carriers. FIG. 3b displays both the dark current and photocurrent of Bi₂WO₆, Bi₂WO₆/NiO and Bi₂WO₆/NiO/Ag. The maximum photocurrent density of Bi₂WO₆/NiO/Ag compared with other catalysts was recorded, suggesting a more efficient charge transfer and separation efficiency as well as longer lifetime of the charge carriers. The enhanced current density of Bi₂WO₆/NiO/Ag perhaps originated from charge transfer between NiO, Ag and Bi₂WO₆ through Z-scheme, which benefits the separation of charge carriers.

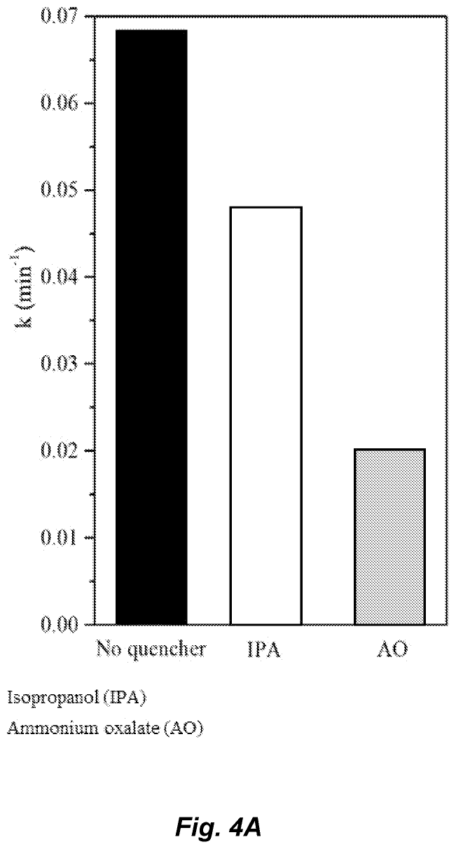

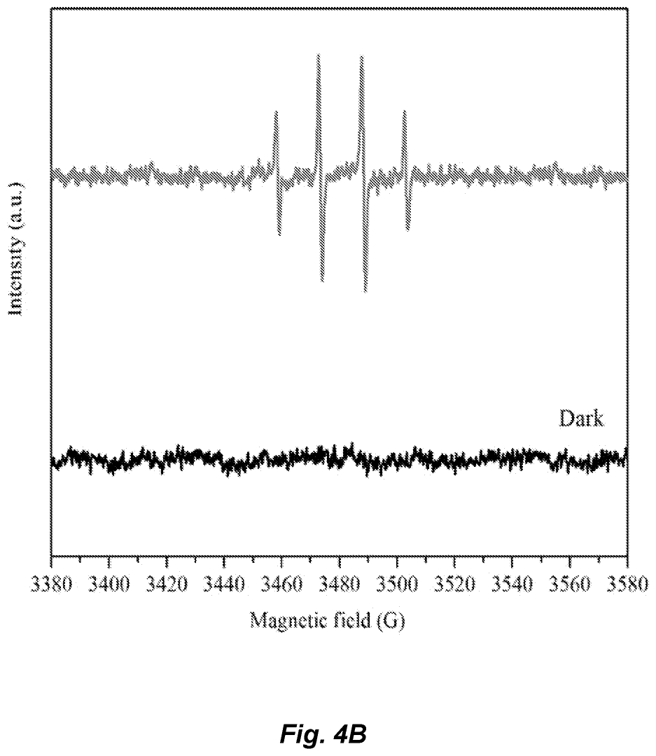

Active species. Generally, when a semiconductor photocatalyst adsorbs photons with energy larger than E_{g}, the photoinduced e⁻ and h⁺ could react with molecular oxygen and H₂O to produce free radicals. These free radicals were investigated through quenching experiments and detected using electron paramagnetic resonance (EPR). The radical trapping experiments were performed to explore the major oxidative substances during the photocatalytic treatment of 1-adamantanecarboxylic acid (ACA). As depicted in FIG. 4a, AO, TEMPOL, K₂Cr₂O₇ and IPA were used as h⁺, O₂^{·-}, e⁻ and ^{·}OH scavengers, respectively. The degradation rate of ACA was significantly inhibited (71.2%) after the addition of AO, indicating that h⁺ was the main oxidizing species. The inhibitory effects of TEMPOL and IPA were 45.2% and 29.7% for the degradation of ACA, demonstrating that ^{·}OH and O₂^{·-} were generated and participated in the photocatalytic degradation. Although O₂ was transformed into O₂^{·-} by photoinduced e⁻, the electron scavenger K₂Cr₂O₇ had less effect on the degradation efficiency of ACA than TEMPOL. K₂Cr₂O₇ could trap electrons to inhibit the recombination of e⁻ and h⁺, leaving more holes to oxidize ACA.

In order to further probe the radical generation and contribution during the photocatalytic process, the EPR spectra with DMPO were used (FIG. 4b). No peaks were detected for either DMPO-O₂^{·-} or DMPO-^{·}OH in the dark. Under light irradiation, Bi₂WO₆/NiO/Ag produced both ^{·}OH and O₂^{·-}, which agreed well with the findings of the quenching tests. Since ^{·}OH and O₂^{·-} are derived from isolated photoinduced e⁻ and h⁺, respectively, the higher peak intensities for ^{·}OH and O₂^{·-} demonstrated that Bi₂WO₆NiO/Ag could improve the separation efficiency of the photogenerated electron-hole pairs in comparison with pure Bi₂WO₆, leading to a boosted photocatalytic performance.

Energy band structure. The optical properties of pure Bi₂WO₆, NiO, Bi₂WO₆/NiO and Bi₂WO₆/NiO/Ag composites were detected using a UV-vis diffuse reflectance spectrometer. The absorption edge of pure Bi₂WO₆ is 430 nm, while NiO shows considerable adsorption from 200 to 800 nm. Moreover, the optical adsorption of Bi₂WO₆/NiO and Bi₂WO₆/NiO/Ag composites were significantly increased in comparison with pure Bi₂WO₆, indicating that the introduction of NiO and Ag onto Bi₂WO₆ obviously widened the absorption range of visible light for the catalysts. The increased visible light absorption range is due to the SPR effect induced by Ag nanoparticles, and the bandgap changes through the addition of NiO and Ag. The band gap (E_{g}) energies were estimated based on the equation αhυ=A(hυ−E_{g})ⁿ, where n=0.5 for direct semiconductor and n=2 for indirect semiconductor. Both NiO and Bi₂WO₆ are direct semiconductors. Therefore, E_{g} of as-prepared samples could be estimated from Tauc's plot, which are approximately 2.76, 3.21, 2.62 and 2.35 eV for pure Bi₂WO₆, NiO, Bi₂WO₆/NiO and Bi₂WO₆/NiO/Ag, respectively. These results revealed that Ag and NiO in the hybrids markedly reduce the band gap of the catalysts. The VB potential of Bi₂WO₆ and NiO were obtained by VB-XPS. The VB of Bi₂WO₆ and NiO were estimated as 2.35 and 0.3 eV. The CB values were calculated accordingly as −0.41 and −2.91, respectively.

Based on these results, as shown in FIG. 5, in a typical Z-scheme structure, the CB of Bi₂WO₆ was negative than the Fermi level of metallic Ag (0.14 eV); therefore, the photoinduced electrons could be easily transfer from CB of Bi₂WO₆ to Ag. After that, the electrons at Ag would migrate to the VB of NiO eventually recombining with h⁺ through a direct electron migration. During this process, the improved electric field intensity around the interface of Ag nanoparticles prompted the interfacial electron transfer and surface electron excitation due to the SPR effect. Meanwhile, the photogenerated holes stayed at the more positive Bi₂WO₆ VB, and electrons were retained in the more negative NiO CB, leading to the production of ^{·}OH and O₂^{·-}. Subsequently, the produced ^{·}OH, O₂^{·-} and h⁺ could oxidize naphthenic acids (NAs) in OSPW.

### Photocatalytic Treatment of OSPW

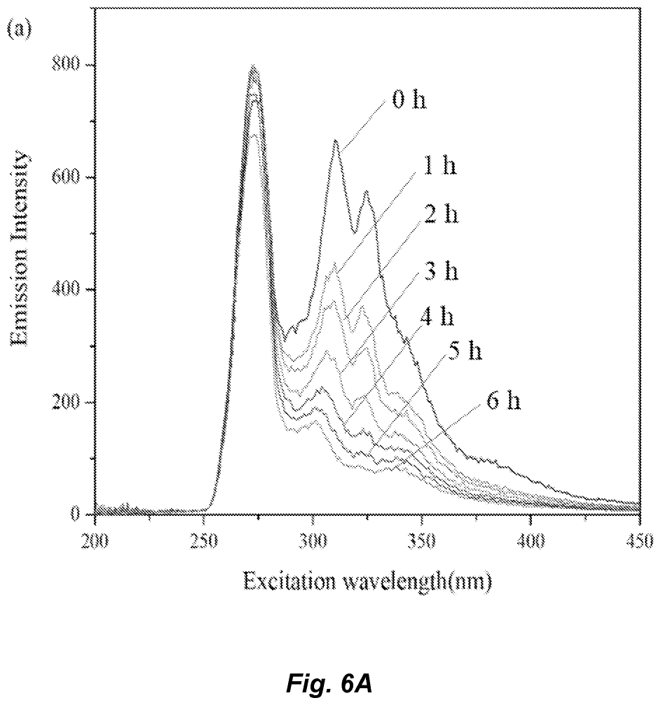

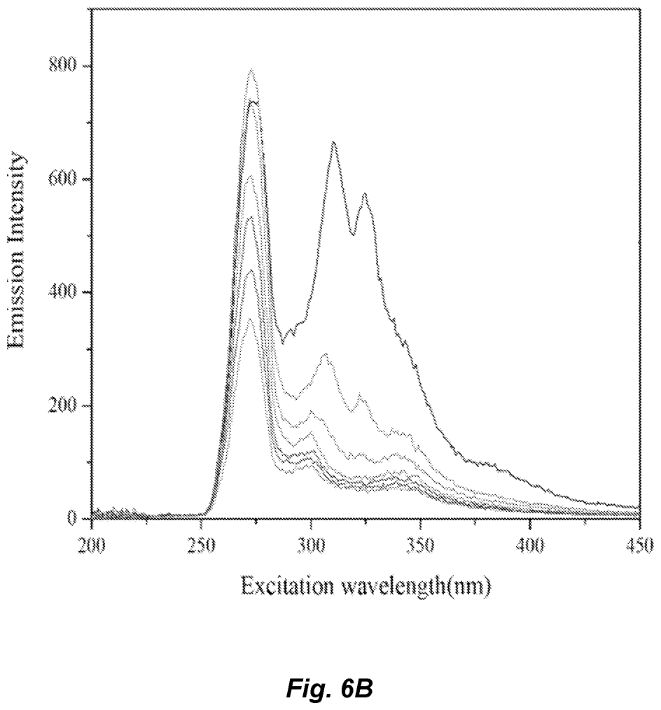

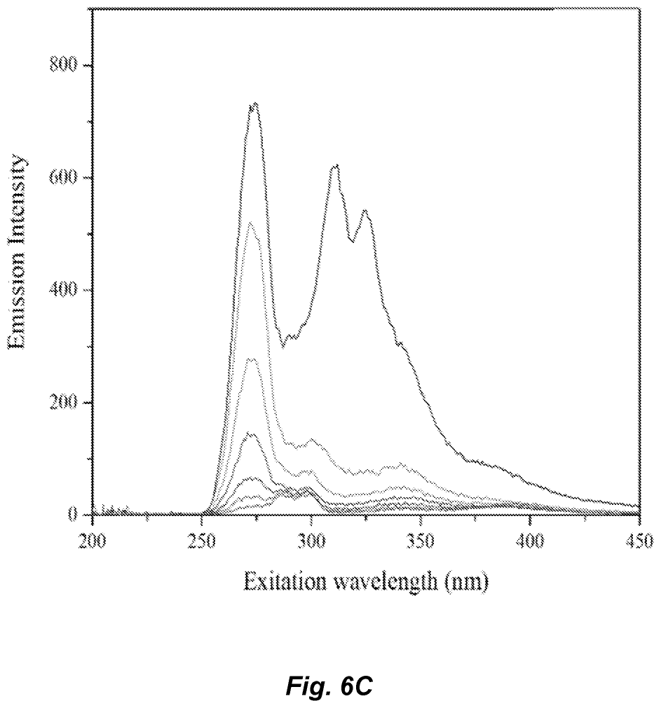

Aromatics degradation. A molecule with a low-energy π/π* transition or n/π* transition is capable of emitting fluorescence when irradiated by UV light. Therefore, SFS was used to detect fluorophore compounds, which are aromatics containing single-ring or fused rings in OSPW. As depicted in FIG. 6, the predominant peak at 267 nm represents the intensity of single-ring aromatics. The other two peaks at 310 nm and 330 nm represent aromatics with two and three fused rings, respectively. The peak areas of all three peaks were generally reduced after photocatalytic treatment by different catalysts. Specifically, after 6 h photocatalytic treatment by Bi₂WO₆/NiO/Ag, all the three peaks were completely removed. The removal rates were 3.4%, 83.5%, 83.3% by Bi₂WO₆; 48.8%, 90.6%, 88.7% by Bi₂WO₆/NiO for aromatics with one ring, two and three fused rings, respectively.

The superior photocatalytic performance for the treatment of OSPW by Bi₂WO₆/NiO/Ag is attributed to the unique Z-scheme electron transfer among NiO, Ag and Bi₂WO₆. The successful separation of e⁻ and h⁺ pairs contributed to the higher production of ^{·}OH, O₂^{·-} and h″, which are oxidative species reacting with aromatics. It was reported that the generation of ^{·}OH, O₂^{·-} and h⁺ could induce the oxidation of the aromatic functional group through electrophilic addition on the aromatic rings, also, hydrogen abstraction through ^{·}OH at the alkyl branches. Therefore, ring opening and electron withdrawing groups were substituted on aromatic rings, resulting in the loss or weakening of aromaticity in aromatics. The low degradation rate of single-ring aromatics (FIG. 6) was due to the transformation of aromatics with multiple rings into single-ring aromatics such as benzoquinone or hydroquinone. In addition to being oxidized by ^{·}OH, O₂^{·-} and h⁺, aromatics could also be degraded by direct and sensitized photolysis during the irradiation, with polyaromatics as photosensitizer.

Naphthenic acid degradation. According to the retention time in LC and the drift time in drift-gas, naphthenic acids (NAs) with different polarity and molecular volume could be separated. Three clusters of NAs illustrated in the IMS spectra of OSPW were observed, namely, classical NAs (O₂-NAs), oxidized NAs (oxy-NAs), and sulfur containing NAs (S-NAs). The highest intensity of oxy-NAs indicates that they account for the majority of raw OSPW. Compared with raw OSPW, significantly degradation of S-NAs and O₂-NAs and negligible decrease of oxy-NAs could be observed after 6 h of photocatalytic treatment by Bi₂WO₆ and Bi₂WO₆/NiO. Previous studies showed that the initial oxidation of S-NAs is usually through the addition of O via electrophilic addition on S atom or heterocyclic ring. For O₂-NAs, hydroxyl-substituted or ketone by-products were produced during the reaction with dissolved oxygen at heterocyclic ring. Thus, the limited degradation of oxy-NAs may be due to the slow degradability of the oxy-NAs or owing to the production of new oxy-NAs from the degradation of S-NAs and O₂-NAs. In contrast, oxy-NAs were partially removed after 6 h of photocatalytic treatment using Bi₂WO₆/NiO/Ag, indicating the improved photocatalytic performance through the construction of Z-scheme heterojunction. The separation of electrons and h⁺ and generation of more reactive species could explain this finding.

In general, classical NAs were considered to be the main toxic NAs in the OSPW. For example, the acute toxicity data of 15 min Microtox bioassay and 96 h fathead minnow embryo lethality showed that the most toxic fraction is classical NAs. The overall distribution of NAs with respect to the-z (hydrogen deficiency) and carbon numbers before and after treatment with the Bi₂WO₆. Bi₂WO₆/NiO and Bi₂WO₆/NiO/Ag were observed. The concentrations of the O₂-NAs and oxy-NAs (the number of O ranging from 3-6) in raw OSPW were 29.5, 18.5, 15.4, 6.3 and 1.4 mg L⁻¹, respectively. The distributions of raw OSPW O₂-NAs based on-z and carbon number are shown in Table 1.

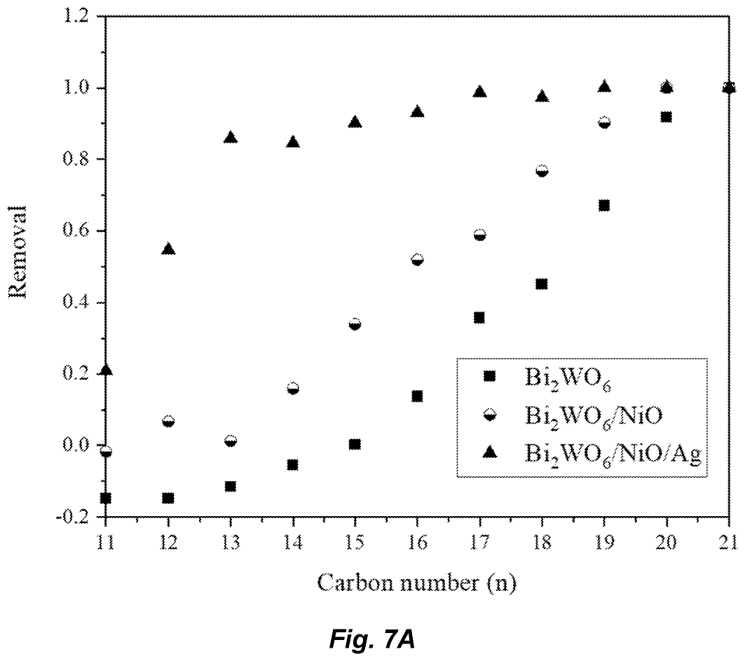

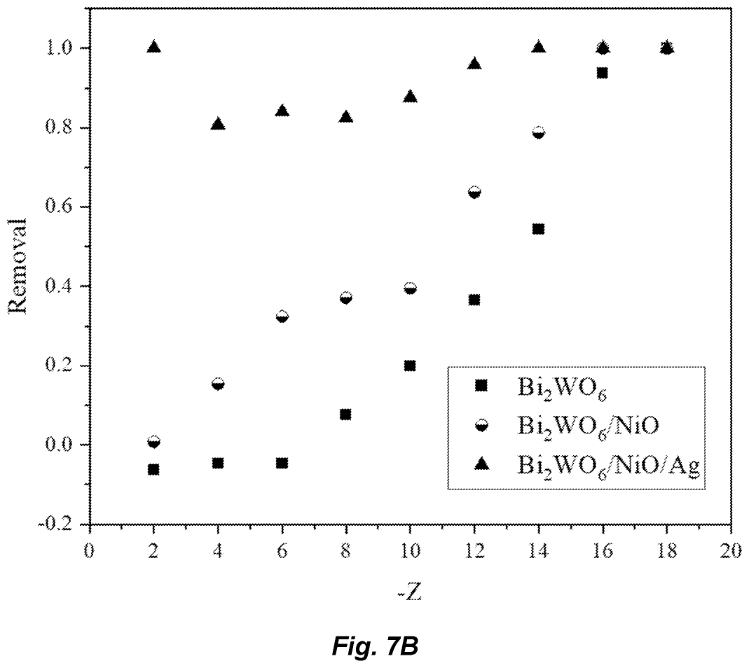

The most abundant species in the O₂-NAs were those with carbon number ranging from 13 to 18 which accounted for 80.2% of the total O₂-NAs, and O₂-NAs with two and three rings (−z=4 and 6) accounted for 47.5% of the total O₂-NAs. The concentration of the O₂-NAs was 29.5 mg L⁻¹ in the raw OSPW, and was reduced to 23.7, 15.3 and 3.37 mg L⁻¹ after treatment with Bi₂WO₆. Bi₂WO₆/NiO and Bi₂WO₆/NiO/Ag, respectively. When the O₂-NAs removal was correlated to the −z and carbon numbers, a clear enhanced removal efficiency of classical NAs by Bi₂WO₆ and Bi₂WO₆/NiO could be recorded with the increasing of-z and carbon number (FIG. 7). Same results were also previously reported for ozone treated OSPW. The reason may be attributed to the increasing available sites of NAs when −z and carbon number increased. The Bi₂WO₆/NiO/Ag showed almost no bias in the removal of NAs regarding the carbon number and −z (FIG. 7).

TABLE 1
Naphthenic acid distributions in the
OSPW based on carbon and z numbers.

| -z | O₂-NAs (%) | Carbon number | O₂-NAs (%) |
|---|---|---|---|
| 0 | 0 | 11 | 1.70% |
| 2 | 1.43% | 12 | 2.73% |
| 4 | 19.55% | 13 | 7.45% |
| 6 | 27.98% | 14 | 12.61% |
| 8 | 8.58% | 15 | 19.16% |
| 10 | 5.07% | 16 | 17.06% |
| 12 | 15.26% | 17 | 12.33% |
| 14 | 9.40% | 18 | 11.54% |
| 16 | 8.44% | 19 | 8.93% |
| 18 | 4.28% | 20 | 4.23% |
| | | 21 | 2.26% |

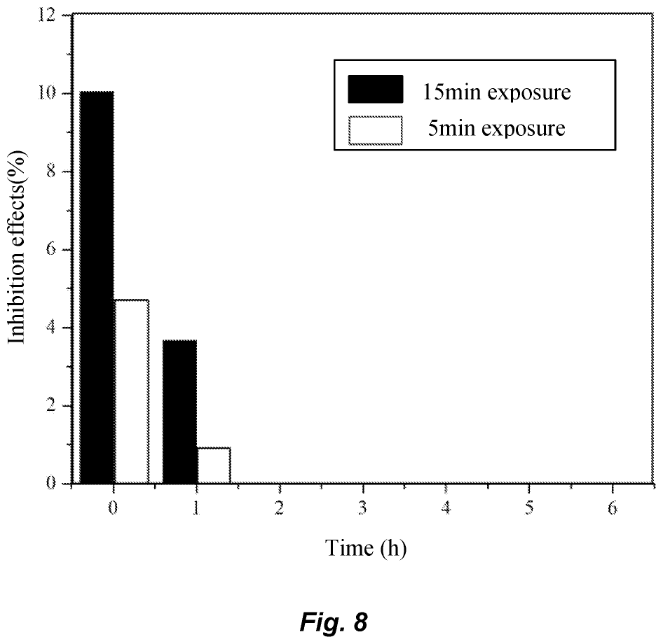

Toxicity. As illustrated in FIG. 8, the raw OSPW showed 10% inhibition effect on Vibrio fischeri. With prolonged photocatalytic treatment, the inhibition effect was reduced. Specifically, there was no inhibition effects observed after 2 h photocatalytic treatment. Previous study found that classical NAs were the most acute toxic NAs in the OSPW. Also, S-containing NAs could induce oxidative stress and inhibit the activity of protein. As illustrated in IMS, we predicted the classical NAs and S-containing NAs were completely removed after 2 h, resulting in the reduced toxicity. These results indicated that the photocatalytic process is a beneficial method for both removal of contaminants and reduction of toxicity.

Conclusion. A ternary plasmonic Bi₂WO₆/NiO/Ag Z-scheme photocatalyst with excellent photocatalytic activity was first successfully synthesized and applied for the OSPW remediation. After 6 h of photocatalytic treatment by Bi₂WO₆/NiO/Ag, all aromatics were completely removed; S-NAs and O₂-NAs were completely removed, and oxy-NAs were partially degraded. The degradation mechanisms of naphthenic acids (NAs) were discussed in depth. ^{·}OH, h⁺ and O₂^{·-} were detected as the key oxidative species in the photocatalytic system. The improved photocatalytic performance of Bi₂WO₆/NiO/Ag was owning to the Z-scheme charge transfer pathway and SPR effect, which prevented the recombination of e⁻ and h⁺, broaden the visible light absorption range, while preserving the excellent redox capacity.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Materials and Methods

Chemicals and materials. Raw OSPW was obtained from an active oil sands tailings pond in Fort McMurray, Alberta, Canada, and was stored at 4° C. in the dark until use. OSPW samples were allowed to reach room temperature (23±2° C.) and particulates were removed by 0.45 μm nylon membranes filter before the experiments. Table 2 lists the properties, major ions, and organic composition of the raw OSPW. Bi(NO₃)₃·5H₂O, Na₂WO₄·2H₂O, Ni(NO₃)₂·6H₂O, ammonium oxalate (AO), urea, isopropanol (IPA), NH₄F, 4-hydroxy2,2,6,6-tetramethylpiperidinyloxy (TEMPOL) and model NA compound, 1-adamantanecarboxylic acid (ACA) were purchased from Sigma Aldrich. The spin-trapping agent 5,5-dimethyl-1-pyrroline-N-oxide (DMPO) was obtained from Dojindo Molecular Technologies Inc.

TABLE 2
Properties, major ions and organic composition of raw OSPW.

| | Value |
|---|---|
| Parameter | |
| pH | 8.7 ± 0.2 |
| Alkalinity (mg L⁻¹ as CaCO₃) | 550 ± 10 |
| Conductivity (mS cm⁻¹) | 3.2 ± 0.2 |
| Total suspended solids (mg L⁻¹) | 41 ± 4 |
| Ions (mg L⁻¹) | |
| K | 41.56 ± 0.702 |
| Na | 1.182 ± 8.306 |
| S | 51.69 ± 0.661 |
| Cl⁻ | 615.3760 ± 5.312 |
| SO₄²⁻ | 93.4347 ± 5.0320 |
| CO₃²⁻ | 1478.3530 ± 30 |
| NO₃⁻ | 19.5539 ± 0.910 |
| Organic parameters (mg L⁻¹) | |
| Dissolved organic carbon (mg L⁻¹ as C) | 52.8 ± 5.2 |
| Classical NAs (O₂-NAs) | 29.46 ± 2.1 |
| O₃-NAs | 18.5 ± 0.8 |
| O₄-NAs | 15.4 ± 0.6 |
| O₅-NAs | 6.3 ± 0.2 |
| O₆-NAS | 1.4 ± 0.2 |

Characterization of materials. The phase purities and crystallinity of the samples were analyzed by X-ray diffraction spectroscopy (XRD). The morphologies were analyzed by scanning electron microscopy (SEM), transmission electron microscopy (TEM), high-resolution transmission electron microscopy (HRTEM). The photoelectrochemical characterization was carried out on an electrochemical workstation with a standard three-electrode system and fluorescence emission spectra were recorded over a wavelength range of 200-800 nm. Active radical species of photocatalysis in aqueous solution were determined by electron paramagnetic resonance (EPR). The details for characterization of the catalysts and the detection of dominant oxidative species in photocatalytic system are discussed next.

The phase purities and crystallinity of the samples were conducted at room temperature on Rigaku X-ray diffraction spectroscopy (XRD) Ultima IV with standard stage (Cu kα radiation, λ=0.15406 nm). The scanning electron microscopy (SEM) images were taken with a Zeiss EVO M10 SEM-imaging. Transmission electron microscopy (TEM) was carried out using a JEOL JEM-ARM200CF S/TEM electron microscope at an accelerating voltage of 200 kV. The high resolution transmission electron microscopy (HRTEM) images were processed by Gatan Digital Micrograph software (Version 3.4.1). The chemical composition was explored by energy-dispersive X-ray spectroscopy (EDX). The chemical states and surface chemical composition were characterized by X-ray photoelectron spectroscopy (XPS, Kratos AXIS 165, Kratos Analytical). Fluorescence emission spectra were recorded over a wavelength range of 200-800 nm on a Horiba Fluorolog 3-22 type fluorescence spectrophotometer with excitation wavelength of 365 nm.

The photoelectrochemical characterization was carried out on an electrochemical workstation with a standard three-electrode system. The as-prepared samples were uniformly coated on the FTO glass as the working electrode. Pt electrode and Ag/AgCl electrode were used as the counter and reference electrodes, respectively. The electrolyte was 0.2 M Na₂SO₄ aqueous solution. A 300 W xenon lamp was applied to provide light source. Active species of photocatalysis in aqueous solution were determined by electron paramagnetic resonance (EPR) with an ELEXSYS-II EPR spectrometer (Bruker E-500, Billerica). The running parameters were as follows: The center field of the spectrometer was 3897 G and resonance frequency (empty) of 9.81 GHz. The EPR spectra were detected with a 100 kHz magnetic field modulation with amplitude of 1.0 G at microwave power of 20 mW and 60 s sweep time. DMPO was used as superoxide radical (O₂^{·-}) and hydroxyl radical (^{·}OH) spin-trapping agent.

Photocatalytic experiments. A solar simulator (Newport, 66485-300XF-R1, USA) was used to perform the photocatalytic experiments. A xenon arc lamp (300 W) was employed, with its irradiance being measured using a spectroradiometer with a CR2 UV-VIS-NIR cosine receptor. Data was acquired by the software program SpectraWiz® (StellarNet Inc.). The irradiance was set and maintained as 18.18 mW cm⁻². The detailed composition of the light spectra is listed in Table 3. The experiments were carried out in a 100 mL cylindrical reactor, in which 50 mg as-prepared samples were added to 50 mL solution to form 1 g L⁻¹ suspension. A magnetic stirrer was employed with speed at 420 rpm. 3 mL samples were sampled at predetermined intervals and the catalysts were immediately filtered with 0.2 μm Nylon filter and stored at 4° C. till analysis.

TABLE 3
The irradiance of different wavelength range.

| Wavelength (nm) | 400-500 | 500-600 | 600-700 | 700-800 | Total |
|---|---|---|---|---|---|
| Irradiance (Watts/m²) | 48.69 | 49.68 | 49.63 | 33.81 | 181.8 |

Analytical method of NAs. The naphthenic acids in raw OSPW and after treatment were analyzed by mass spectrometry, ion mobility spectrometry (IMS), and synchronous fluorescence spectra (SFS). The details of the analytical procedures are as follows.

Synchronous fluorescence spectra (SFS) of the filtered water were recorded with Varian Cary Eclipse fluorescence spectrometer. Excitation wavelengths ranged from 200 to 600 nm, and emission wavelengths were recorded from 218 to 618 nm. Scanning speed was 600 nm/min and the photomultiplier (PMT) voltage was 800 mV. SFS of OSPW provides specific information on fluorescing compounds: peak I at 267 nm is assigned to one ring aromatics, while peak II at 310 nm and peak III at 330 nm are assigned to aromatics with two and three fused rings, respectively.

The concentration of a model NA compound was measured by an ultra-performance liquid chromatograph (UPLC) coupled with a single quadrupole mass spectrometry (SQ Detector 2, Waters). Chromatographic separation was performed at a flow rate of 400 μL min⁻¹ by a BEH C18 column (2.1 mm×100 mm×1.7 μm, Waters) maintained at 40° C. The mobile phase was 0.1% formic acid in water (A) and methanol (B). The MS was operated in a negative ion mode using an ESI source in single ion monitoring mode. For OSPW samples, 1 mL of each water sample was centrifuged at 10000 RPM for 10 min. The injection solution was prepared with 500 μL of the supernatant, 100 μL of 4.0 mg L⁻¹ internal standard (ISTD) compound (Myristic acid-1-¹³C) in methanol, and 400 μL methanol to reach a final sample volume of 1 mL.

The samples were analyzed using UPLC-TOF-MS in high-resolution mode (mass resolution=40000 FWHM at 1431 m/z) at mass range of 100-600 (m/z). The electrospray ionization source was operated in the negative mode to measure NAs in the samples. Data acquisition was controlled using MassLynx (Waters) and data analysis was performed using TargetLynx (Waters). One raw OSPW sample was used as the quality control sample to ensure the method stability. This method was developed previously for semi-quantification of NAs based on the signal of a compound versus the signal of spiked ISTD. The chromatographic separation was achieved by a method developed in our previous reports for the separation of NAs (Environmental Science & Technology, 47 (2013) 6518).

The ion-mobility spectrometry (IMS) was conducted in a Tri-Wave® ion-mobility cell of 15 cm long, using nitrogen (purity>99%) as the drift gas. The IMS consisted of a transfer cell that collected certain amounts of ions and a helium gate that released the ions into the ion mobility cell. The number of ions was known and the difference in the number ions had a threshold of 5%. Ions were separated using an electric field (T-wave) that moved the ions in one direction and a gas flow in the counter direction, which drifted the ions based on the cross-collision section (CCS). Drift-Scope ver. was used to control the mobility separation. One raw OSPW sample was used as the quality control sample to ensure the method stability.

Toxicity towards Vibrio fischeri. The toxicity of the raw and photocatalytic treated OSPW was measured by the inhibition of the bacteria (Vibrio fischeri, also known as Aliivibrio fischeri) luminescence. Reagent phenol was used as a positive control. After 15 min of exposure to the OSPW at 15° C., the data of luminescence was recorded using microplate reader after 5 and 15 min, respectively.

### Example 2. Preparation of Photocatalysts

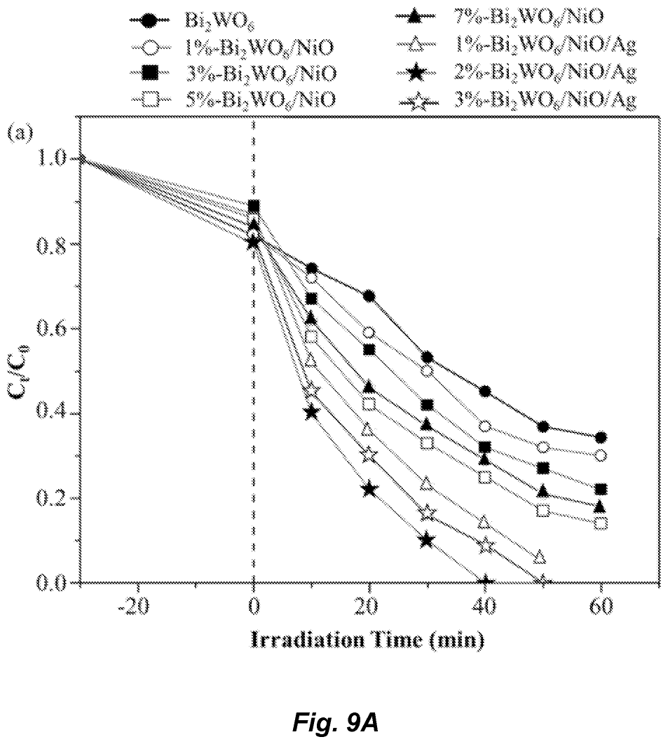

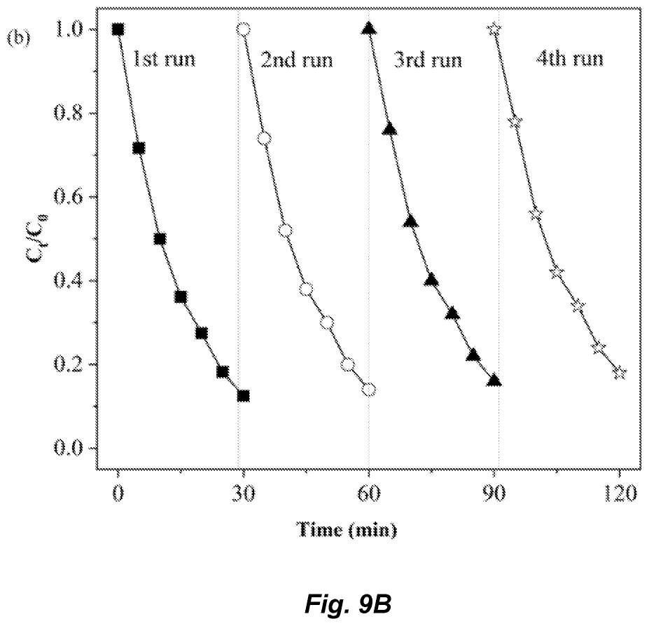

The self-assembled 3D flower like Bi₂WO₆ was fabricated via hydrothermal methods followed by the deposition of OD Ag nanoparticles and 2D NiO nanoplates using in-situ light reduction and hydrothermal methods forming Bi₂WO₆/NiO/Ag Z-scheme heterojunction. The detailed methods are described below. The loading amounts of NiO and Ag were optimized using the degradation of ACA and were found to be 5% of NiO and 2% of Ag (FIG. 9). The reusability and stability of the fabricated photocatalyst were also conducted through the degradation of ACA (FIG. 9). Details of the experiments and results are discussed in Example 3.

For the preparation of Bi₂WO₆, Bi(NO₃)₃·5H₂O (2 mmol) was added into 10 mL glacial acetic acid under magnetic stirring until it became a clear solution (solution A). 1 mmol of Na₂WO₄·2H₂O was dissolved in 70 mL water to form solution B. Next, solution B was added dropwise into solution A. The mixture was stirred for 1 h and then treated with a hydrothermal method at 140° C. for 8 h. The obtained products were centrifuged, washed with ultrapure water and ethanol three times, and dried at 60° C. for 6 h.

The Bi₂WO₆/NiO heterojunction composites were obtained by the following process: 0.4 g Bi₂WO₆ was added in 60 mL water under magnetic stirring for 30 min. After that, urea (1 g), NH₄F (0.2 g) and appropriate amounts of Ni(NO₃)₂·6H₂O were added into the solution and stirred vigorously for 30 min. Then, the solution was transferred into a Teflon-lined stainless-steel autoclave, which was heated at 160° C. for 12 h. The resulting composites were washed with ultrapure water and ethanol and dried at 60° C. Subsequently, the Bi₂WO₆/NiO composites with a dark-green color were obtained by calcining in air at 380° C. for 2 h. The pure NiO was obtained by the same method but without the addition of Bi₂WO₆.

The Bi₂WO₆/NiO/Ag plasmonic composites were prepared by a photoinduced method as follows: certain amounts of AgNO₃ and oxalic acid were added into 20 mL deionized water and then stirred vigorously until the chemicals were completely dissolved in the dark. After that, the as-prepared Bi₂WO₆/NiO composites were dispersed into the above solution and irradiated for 3 h with a 300 W Xe lamp under magnetic stirring. The final Bi₂WO₆/NiO/Ag products were collected, washed and dried at 60° C.

### Example 3. ACA Experiments

1-Adamantanecarboxylic acid (ACA) is a typical classical naphthenic acid (NA) and are widely used to explore the degradation kinetics and mechanisms of NAs. Therefore, it was selected to evaluate the photocatalytic activity of the prepared catalysts. FIG. 9a shows the photocatalytic degradation curve of ACA as a function of time. A dark adsorption experiment was conducted for 30 min before the solar irradiation to achieve adsorption equilibrium. It is clear that the heterojunction catalysts were all more efficient than the pure Bi₂WO₆. With the increase in NiO and Ag content in the nanohybrid, the photocatalytic activity of the composite initially increased and then decreased. Specifically, 5% of NiO and 2% of Ag exhibited the best ACA photodegradation efficiency with reaction rates of 0.0301 and 0.0684 min⁻¹, respectively. The appropriate amount NiO and Ag anchored on the surface of Bi₂WO₆ could improve the transfer of photoexcited charges and restrain the recombination of photogenerated electron-hole pairs. However, the high composition of NiO and Ag deposited on the Bi₂WO₆ might reduce the number of exposed active sites and inhibit the transfer of photogenerated charge carriers, thus decreasing the photodegradation efficiency of the ACA. The photocatalytic degradation experiments were repeated three more times to assess the reusability and stability of the catalysts (FIG. 9b). The cycling experiment indicates that Bi₂WO₆/NiO/Ag still retained its efficient photocatalytic properties after multiple runs. The slightly reduced catalytic efficiency was ascribed to the small mass loss during the inevitably incomplete photocatalyst collection and decreased adsorption capacity.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. A photocatalyst composite, the composite characterized by having a Z-scheme heterojunction structure of uniformly distributed components, wherein the components of the composite comprise Bi₂WO₆ and NiO, the weight percent of Bi₂WO₆ is at least 85%, the weight percent of NiO is at least 1%, and the composite is capable of oxidizing an organic compound via Z-scheme charge transfer;
wherein optionally the weight percent of NiO is about 3% to about 7%; and
wherein optionally the weight percent of Bi₂WO₆ is at least 90%.

2. The photocatalyst composite of claim 1 wherein the components of the composite further comprise a noble metal.

3. The photocatalyst composite of claim 2 wherein the noble metal is silver.

4. The photocatalyst composite of claim 2 wherein the weight percent of the noble metal is at least 0.5%; or
wherein the weight percent of the noble metal is about 1% to about 5%.

5. The photocatalyst composite of claim 2 wherein the weight percent of NiO is about 3% to about 7%, and weight percent of the noble metal is about 1% to about 5%.

6. The photocatalyst composite of claim 2 wherein the weight percent of Bi₂WO₆ is about 93%, the weight percent of NiO is about 5%, and weight percent of the noble metal is about 2%.

7. The photocatalyst composite of claim 2 wherein the components of the composite consist essentially of Bi₂WO₆, NiO and Ag.

8. A method for oxidizing a compound comprising irradiating a mixture comprising a photocatalyst composite of claim 1 and one or more organic compounds for a sufficient period of time to oxidize the one or more organic compounds;
wherein optionally the irradiating comprises solar irradiation.

9. The method of claim 8 wherein the photocatalyst composite is Bi₂WO₆/NiO/Ag, the weight percent of Bi₂WO₆ is about 93%, the weight percent of NiO is about 5%, and weight percent of the noble metal is about 2%.

10. The method of claim 8 wherein the irradiating is at a wavelength of about 400 nm to about 800 nm; or
wherein the irradiating is at a wattage of about 30 Watts/m² to about 200 Watts/m².

11. The method of claim 8 wherein the one or more organic compounds comprises naphthenic acids and/or aromatic compounds.

12. The method of claim 8 wherein the mixture is an aqueous solution comprising the photocatalyst composite and the one or more organic compounds; or
wherein the one or more organic compounds are present in oil sands process water (OSPW) and are oxidized sufficiently to be environmentally safe.

13. The method of claim 8 wherein the sufficient period of time is about 2 hours.

14. A method for preparing a photocatalyst composite of claim 1 comprising:
a) autoclaving an aqueous mixture comprising a bismuth(III) salt and a tungstate salt to form Bi₂WO₆, wherein the Bi₂WO₆ has a flower-like, swirl-like, or nanoplate morphology;
b) autoclaving a second aqueous mixture comprising the Bi₂WO₆, a urea, fluoride ion, and nickel(II) to form a Bi₂WO₆/NiO composite;
c) calcining the Bi₂WO₆/NiO composite while exposed to air;
d) irradiating a third aqueous mixture of the calcined Bi₂WO₆/NiO composite, a silver salt, and an organic acid to form a plasmonic Bi₂WO₆/NiO/Ag photocatalyst composite;
wherein each autoclaving step is at a temperature of at least 120° C.

15. The method of claim 14 wherein the mixture of step a) further comprises an organic acid and/or a surfactant.
